(19) United States
(12) Patent Application Publication
(10) Pub. No.: US 2018/0139934 A1
(43) Pub. Date: May 24, 2018

(54) INSTANT HONEY EXTRACTION AND DISPENSING CONTAINER

(71) Applicant: Eran MAUSNER, Tel-Aviv (IL)

(72) Inventor: Eran MAUSNER, Tel-Aviv (IL)

(21) Appl. No.: 15/572,791

(22) PCT Filed: Dec. 25, 2016
(86) PCT No.: PCT/IL2016/051378

§ 371 Date: Nov. 9, 2017

(30) Foreign Application Priority Data
Dec. 27, 2015 (IL) 243340

(51) Int. Cl. A01K 59/04

(52) U.S. Cl. CPC A01K 59/04

(57) ABSTRACT

There is provided herein a honey extraction and dispensing container comprising: a jar; a rotatable lid mounted on top of said jar such that said jar is a sealed jar; a threaded rod attached to the underside of said lid; a compression surface wherein said threaded rod is threaded through a threaded opening in said surface; and at least one honeycomb mounted beneath said surface inside said sealed jar; wherein rotation of said lid causes rotation of said threaded rod through said threaded opening causing said surface to descend and to compress said honeycomb, wherein said lid does not descend during said rotation.

### FIELD OF THE INVENTION

The present invention is of a container for extracting and dispensing honey from honeycomb and in particular, such a container that is sealed and of similar proportions to consumer honey products.

### BACKGROUND

Honey consumers are able to acquire actual honeycomb and many consider the honey that is extracted to be healthier than packaged honey. These consumers generally rely on primitive extraction methods such as scraping the honey from the honeycomb. The difficulty of extracting the honey and the associated messiness generally dissuades consumers from purchasing honeycomb even though they would prefer to consume honeycomb honey.

Beyond extraction there are further issues such as the need to filter the extracted honey and the difficulty of extracting partial amounts of honey from the comb when not all of the honey in the comb needs to be used at once.

Current efficient extraction methods are based primarily on expensive industrial machinery not suited to consumers. The primary industrial mechanism used today is based on centrifuges that spin several combs and collect the honey pulled out by centrifugal force. Large honey presses are available to hobbyists but these are expensive, difficult to clean and are designed to compress multiple combs, requiring storage of the collected honey. It is not practical to compress a small part of honeycomb using such a large press while leaving the remainder for later use.

U.S. Pat. No. 1,073,459 to Anderson provides for honeycomb filled with honey by bees where the honeycomb is provided in jars—but no extraction method is suggested or provided. Juice presses such as U.S. Pat. No. 1,294,211 to Webley are also not suitable as they rely on the liquid floating above the squashed fruit to enable extraction. By contrast honey has a much thicker consistency and is not easily retrieved from such a press. In addition, the press suffers from the issues raised above namely, size, expense, difficulty in cleaning and unsuitability for partial extraction.

There is therefore no convenient method for a consumer to purchase honeycomb and then extract the honey from the honeycomb and it would be advantageous to have a single container capable of both storing the honeycomb and instantly extracting honey at will without great expense or mess.

### SUMMARY OF THE INVENTION

The present invention overcomes the deficiencies of the background art by providing an instant honey extraction and dispensing container that is sized according to comparable consumer honey products but enables compression of honeycomb to extract comb honey at will in any amount.

The container comprises a jar similar to honey jars sold to consumers, wherein the jar is sealed with a rotatable lid. The rotatable lid turns a threaded rod which in turn drives a compression surface downwards inside the jar. A number of honeycombs are mounted in the purchased jar beneath the surface and the compression surface gradually compresses these to release honey. The released honey then pours out of the jar through a spout conveniently located near the bottom of the jar. An optional cleanable filter in the spout filters the comb honey as it exits the jar. The spout may also be capped to prevent honey leaking out.

When the rotation of the lid is ceased, the compression of the combs ceases and no more honey is extracted. The partially compressed combs are then stored in the container until more honey is needed.

Thus a consumer can efficiently extract honey from honeycomb in any amount necessary, without the mess commonly associated with honeycomb. Once the honey in the comb is exhausted the container may be discarded. Optionally, the container may be reusable.

According to some embodiments of the present invention, a honey extraction and dispensing container comprises: a jar; a rotatable top mounted on top of said jar; a threaded rod attached to said top; a compression surface wherein said threaded rod is threaded through a threaded opening in said surface; and at least one honeycomb mounted beneath said surface inside said jar; wherein rotation of said top causes rotation of said rod causing said surface to compress said honeycomb. Preferably the compression of said honeycomb results in the extraction of honey from said honeycomb.

Preferably, the container further comprises a spout, wherein extracted honey is drained through said spout. Preferably, the container further comprises a cap to close said spout. Preferably, the container further comprises a filter positioned before the drainage of the extracted honey from said jar. Optionally the filter is a cleanable filter.

Preferably the top is not removable such that said jar cannot be reused. Optionally, the honeycomb is mounted inside said jar using at least one of, pressure mounting, mounting pins or a mounting substrate. Optionally a seal is positioned between said surface and said jar. Optionally, compression teeth are mounted on the underside of said surface. Optionally an alignment strip is fixedly attached to the inside of said jar.

Optionally the honeycomb is mounted vertically. Optionally the honeycomb is mounted horizontally. Optionally a plurality of layers of honeycomb are each mounted on separate surfaces. Optionally, the container is not reusable. Optionally the shape of said jar is selected from the group consisting of circular, square, rectangular, and hexagonal.

According to other embodiments of the present invention a system for extracting honey from honeycomb comprises: a sealed jar comprising a rotatable top, a compression surface, and a spout; and honeycomb mounted inside said jar beneath said surface; wherein rotation of said top causes said surface to compress said honeycomb for extraction of honey through said spout, wherein said top is attached to a threaded rod and wherein said rod is threaded through a threaded opening in said surface.

According to other embodiments of the present invention a honey extraction and dispensing container for extracting honey from a honeycomb comprises: a jar; a rotatable top mounted on top of said jar; a threaded rod attached to said top; and a compression surface wherein said threaded rod is threaded through a threaded opening in said surface; wherein rotation of said top causes rotation of said rod causing said surface to compress a honeycomb mounted in said jar.

The terms jar or container as used herein refers to any container and may be of any shape or comprise any material. The terms honeycomb and comb are used herein interchangeably. The term “comb honey” refers to honey extracted from a comb as opposed to packaged honey which is purchased in an already-extracted form. The term reusable as used herein implies the ability to open the jar and replace the honeycomb or install new honeycomb in an empty container. Both of a reusable and a non-reusable container may be defined as sealed herein implying that the mechanism and contents are essentially completely enclosed.

Implementation of the method and system of the present invention involves performing or completing certain selected tasks or steps manually, automatically, or a combination thereof.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is an exemplary illustration of an instant honey extraction and dispensing container according to at least some embodiments of the present invention;

FIG. 1B is a schematic side view of the top of an instant honey extraction and dispensing container according to at least some embodiments of the present invention;

FIGS. 2A and 2B are schematic side views of an instant honey extraction and dispensing container showing extraction of honey according to at least some embodiments of the present invention;

FIGS. 3A-3D are respectively side, plan, rotated side and cross-sectional plan schematic illustrations of an instant honey extraction and dispensing container according to at least some embodiments of the present invention;

FIGS. 4A-4C are respectively side, rotated side and cross-sectional plan schematic illustrations of an instant honey extraction and dispensing container according to at least some embodiments of the present invention;

FIGS. 5A-5D are respectively side, cross-sectional plan, rotated cross-sectional side and plan schematic illustrations of an instant honey extraction and dispensing container according to at least some embodiments of the present invention;

FIGS. 6A-6D are respectively side, cross-sectional plan, rotated side and plan schematic illustrations of an instant honey extraction and dispensing container according to at least some embodiments of the present invention; and

FIGS. 7A-7D are respectively side, cross-sectional plan, rotated side and plan schematic illustrations of an instant honey extraction and dispensing container according to at least some embodiments of the present invention.

### DESCRIPTION OF THE PREFERRED EMBODIMENTS

The present invention is of an instant honey extraction and dispensing container that is sized according to comparable consumer honey products but enables compression of honeycomb to extract comb honey at will in any amount.

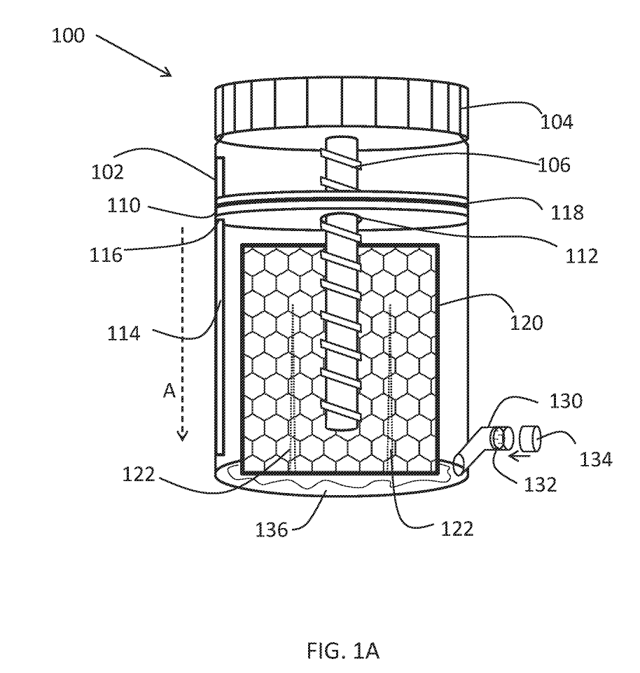

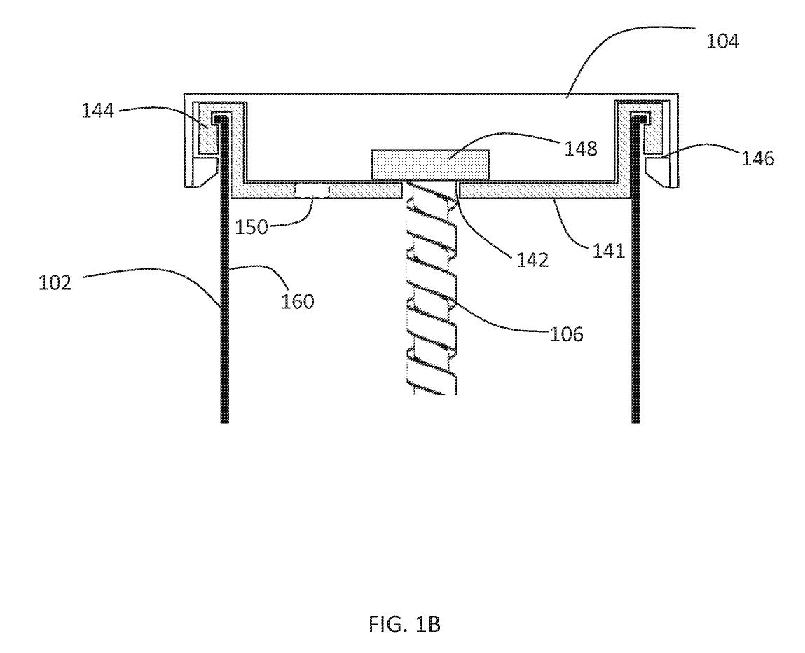

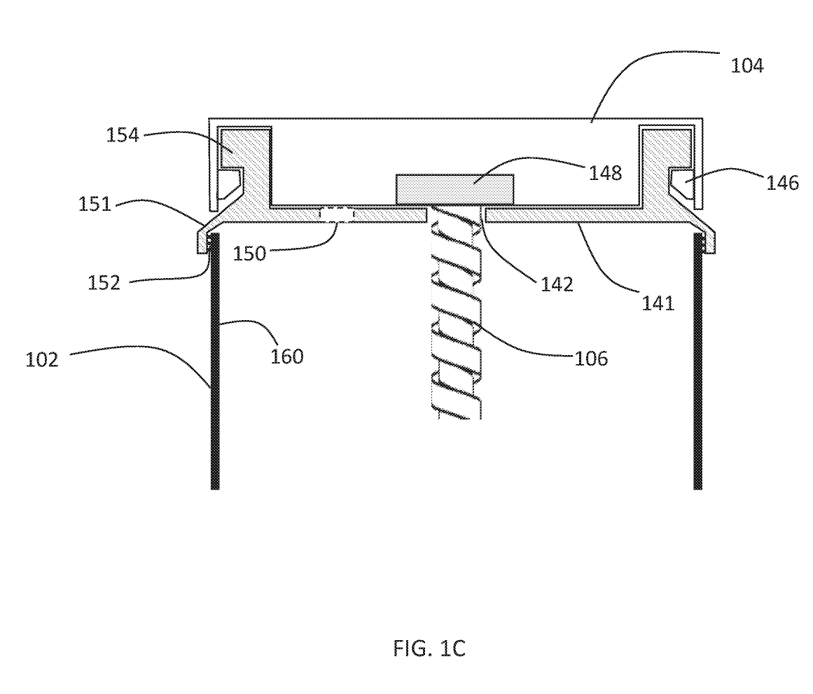

Reference is now made to FIG. 1A which is an exemplary illustration of an instant honey extraction and dispensing container according to at least some embodiments of the present invention. As shown in FIG. 1A, an instant honey extraction and dispensing container 100 comprises jar 102, which is here shown as a transparent cylindrical jar.

Without limiting the possible shapes, jar 102 may optionally be cylindrical, square, hexagonal or any other shape suited to the functionality as laid out herein including combinations of shapes. Jar 102 may optionally be of a unique design to allow easy identification by consumers. Jar 102 preferably conforms to the dimensions of honey containers commonly sold to consumers. Jar 102 is optionally 15 cm×10 cm×1.0 cm. Jar 102 is optionally up to 20 cm high or optionally up to 30 cm high or optionally up to 40 cm high. Jar 102 is optionally up to 20 cm wide or optionally up to 30 cm wide or optionally up to 40 cm wide. Jar 102 is optionally up to 20 cm long or optionally up to 30 cm long or optionally up to 40 cm long. Container 100 including all contents as described below preferably weighs the same or similar weight as honey containers filled with honey available for consumer purchase. Container 100 including all contents as described below optionally weighs less than 5 kg or less than 1 kg.

Container 100 including all components described herein may be manufactured from any suitable food-safe material, which, without limiting the material to a closed list, optionally includes glass, plastic, PMMA, stainless steel or a combination of these.

Jar 102 is sealed at its top by rotating top 104. Top 104 comprises ridges or any other non-smooth surface around its sides to allow a better grip for rotating top 104. Top 104 is further described below with reference to FIG. 1B. A screw-like threaded rod 106 is fixedly attached to the underside of top 104 at its center such that rotation of top 104 results in rotation of rod 106. The thread of rod 106 is angled such that rotation of top 104 causes the desired upward or downward rotation of the thread. The connection of top 104 to rod 106 is optionally via a geared mechanism (not shown) such that rotation of top 104 causes fewer or greater rotations of rod 106. Such a mechanism may ease the rotational force that needs to be exerted in operation of the container 100.

Top 104 optionally comprises an arrow embossed or printed on its upper surface indication the correct direction that top 104 should be rotated in. Top 104 optionally comprises a ratchet or similar mechanism (not shown) that will only allow rotation of top 104 in one direction. While maintaining the ability to rotate, top 104 is preferably fixedly attached to jar 102 such that container 100 may not be opened or reused once the honeycomb is fully used. Optionally, top 104 can be removed allowing reuse of the container.

Threaded rod 106 extends down from top 104 to most of the height of jar 102. Optionally, rod 106 extends downwards for the full height. Rod 106 is threaded through a threaded opening 112 in compression surface 110 such that rotation of rod 106 results in movement of surface 110 either upwards or downwards inside jar 102. As described above, optionally top 104 includes a mechanism to limit the turning such that surface 110 only moves downwards such as indicated by arrow A. Surface 110 is itself prevented from turning by alignment strip 114. Strip 114 is fixedly attached to the side of jar 102 and extends along the side of jar 102 for the length of travel of surface 110. Strip 114 fits into surface 110 at notch 116 in surface 110. Surface 110 is provided around its outside with seal 118 to prevent extracted honey from leaking above surface 110. Surface 110 also comprises a seal (not shown) around opening 112 to similarly prevent honey leakage. Surface 110 is shaped to fit the shape of jar 102 such that seal 118 is in contact with the inner surface of jar 102. Surface 110 may therefore optionally be circular, square, rectangular, hexagonal or of any shape according to the shape of jar 102.

Honeycomb 120 is mounted inside jar 102. Optionally honeycomb 120 is sized so as to snugly fit inside jar 102 and optionally honeycomb 120 is thus held in position by pressure exerted on it by jar 102 and/or surface 110. Optionally honeycomb is mounted on optional deformable mounting pins 122 which secure comb 120 in an upright position. Optional pins 122 are fixedly attached to the base of jar 102. Optionally any other means may be used to hold comb 120 in position. FIG. 1A shows a single comb mounted inside jar 102, however it should be appreciated that any number of combs can be mounted inside jar 102 depending on the shape of jar 102 and the shape of the combs to be mounted. Comb 120 comprises a natural or artificial frame filled with honey. Combs may either be capped with wax or uncapped.

Spout 130 is provided at the bottom of jar 102 for dispensing of extracted honey. Spout 130 may be positioned at the very base 136 of jar 102 or slightly above the base 136. Base 136 may optionally slope downwards (not shown) towards spout 130 so that extracted honey flows towards spout 130. Spout 130 may be of any suitable size to allow outflow of honey. Optionally spout 130 is between 5 mm to 1 cm in diameter. Optionally, spout 130 is up to 2 cm in diameter.

Filter 132 is positioned inside spout 130 to filter the dispensed honey. Filter 132 is optionally removable to allow for cleaning of filter 132. Spout 130 is preferably closeable with cap 134 that fits over the outlet of spout 130. Cap 134 is secured using means known in the art such as screwing or a pressure-based seal.

Reference is now made to FIGS. 1B and 1C which are schematic side views of the top of an instant honey extraction and dispensing container according to at least some embodiments of the present invention. FIG. 1B and 1C illustrate optional embodiments for the fixation of top 104 to jar 102 to allow the rotation of top 104. Optionally any other system may be used. As shown, top 104 further comprises base 141. Base 141 has an opening 142 through which rod 106 passes.

In the embodiment of FIG. 1B, jar 102 has a width that is smaller than that of top 104. Base 141 is fixedly attached to jar 102 such as by contoured edges 144 that extend around the top of jar 102. The contents of container 100 such as honeycomb 120 and surface 110 are inserted before fixation of top 104. Protrusions 146 which are fixedly attached to top 104 prevent top 104 from being removed from jar 102 but allow for rotation of top 104.

In the embodiment of FIG. 1C, jar 102 has a width that is larger than or equal to that of top 104. Base 141 therefore includes a width adjustment flange 151 that is attached to jar 102 at attachment point 152. The contents of container 100 such as honeycomb 120 and surface 110 are inserted before fixation of top 104 at attachment point 152. The attachment at 152 may be via a threaded screw-on mechanism or a mechanical clip-on mechanism or any other means. Attachment at point 152 is preferably fixed by any means known, including but not limited to gluing or welding such that container 100 cannot be opened. Optionally the attachment is not fixed such that top 104 can be separated from jar 102 to allow access to the contents of jar 102. Contoured edges 154 extend around base 141 and abut against protrusions 146 which are fixedly attached to top 104 to prevent top 104 from being removed from jar 102 but allow for rotation of top 104.

As shown in both embodiments, top 104 is fixedly attached to rod 106 at the top 148 of rod 106. Fixation of rod 106 to top 104 may be by any means known in the art, not limited to a bolt, glue, or any other means. As top 104 is turned and surface 110 descends, a vacuum is prevented from forming between top 104 and surface 110 as air can enter jar 102 via opening 142 or via optional valve 150 in base 141.

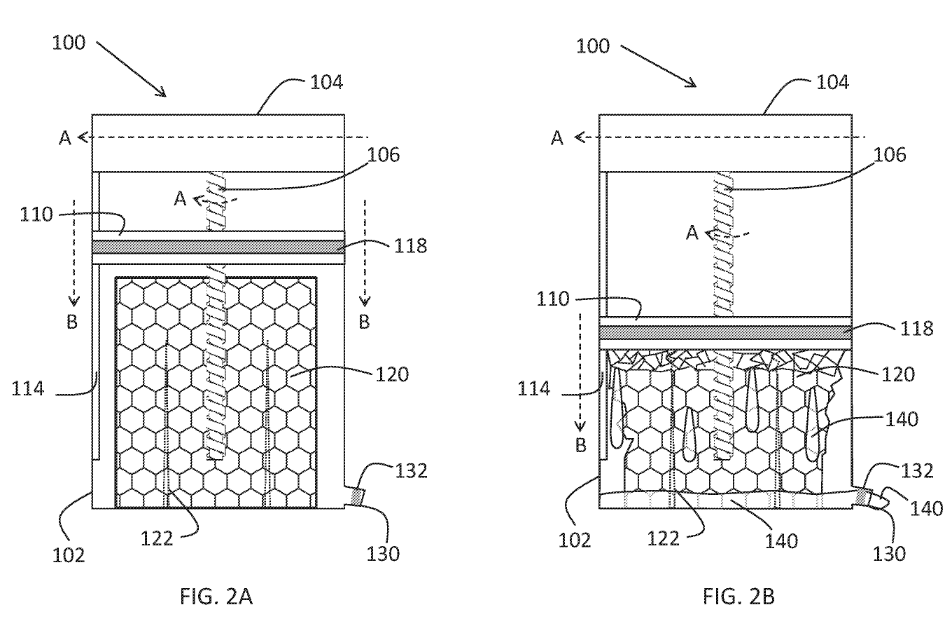

Reference is now made to FIGS. 2A and 2B which are schematic side views of an instant honey extraction and dispensing container showing extraction of honey according to at least some embodiments of the present invention. As shown in FIG. 2A container 100 is provided with comb 120 mounted inside. When honey is required, top 104 is rotated in direction A such as by a consumer. This results in rotation of rod 106 in direction A. The rotation of rod 106 results in downward movement of surface 110 in direction B toward comb 120 which is mounted on optional pins 122. Strip 114 prevents rotation of surface 110 thus forcing surface 110 to move based on the turning thread of rod 106.

As shown in FIG. 2B, surface 110 gradually compresses comb 120 such that the honey 140 inside the comb is squeezed out. Honey 140 settles on the bottom of jar 102 and flows out of spout 130 via optional filter 132. Optional pins 122 are gradually deformed by surface 110 but continue to hold comb 120 in its mounted position. Seal 118 prevents honey 140 from squeezing past surface 110.

When sufficient honey has been extracted from container 100, rotation of top 104 is ceased by, for example, the consumer and no further honey is extracted out of comb 120. Container 100 can then be stored until such time as more honey is required, and the process may be repeated to extract more honey. The system therefore allows gradual extraction of the honey from the comb as required and the complete extraction does not need to be performed on a single occasion. When comb 120 is fully depleted of honey or when no further rotation of top 104 is possible due to the extensive compression of comb 120 or surface 110 having reached the end of the thread of rod 106, the container may be discarded.

In an optional embodiment where container 100 is refillable, top 104 may be removed from container 100 along with surface 110 to allow the cleaning of container 100 and the insertion of new comb. Surface 110 and top are then reinserted and reattached or alternatively replaced and the container may be used to extract honey from the new comb as described above.

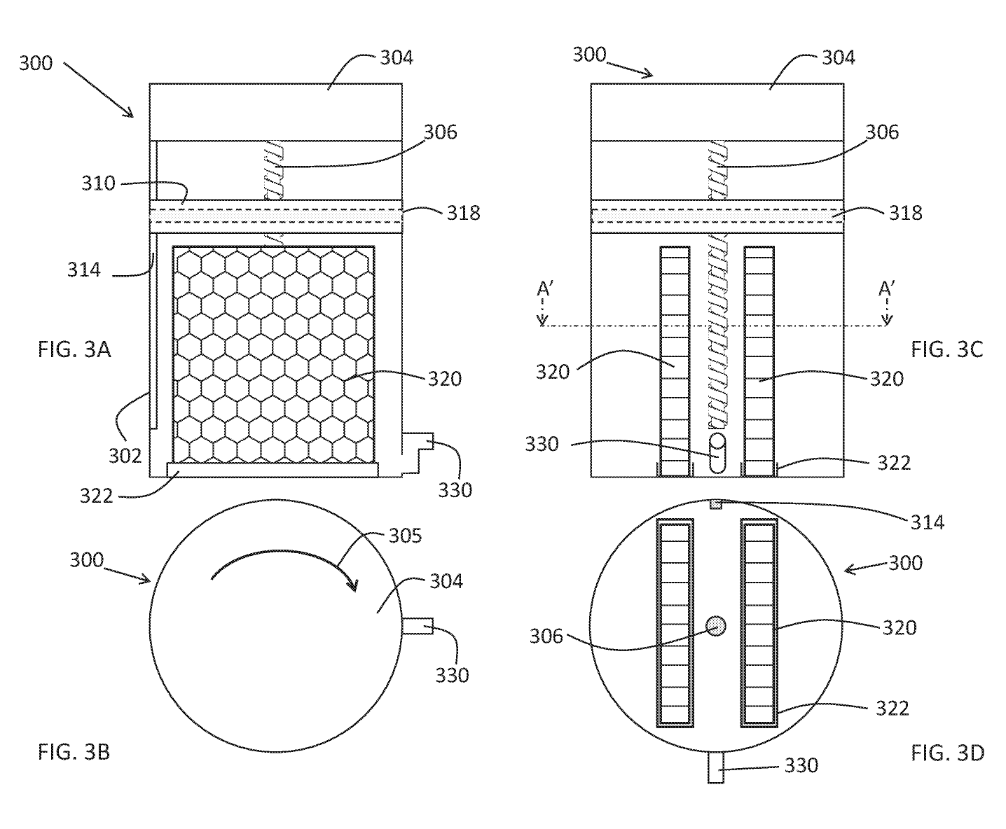

Reference is now made to FIGS. 3A-3D which are respectively side, plan, rotated side, and cross-sectional plan schematic illustrations of an instant honey extraction and dispensing container according to at least some embodiments of the present invention. FIGS. 3C and 3D are rotated 90 degrees with respect to FIGS. 3A and 3B. FIG. 3D is a cross section A′-A′ of FIG. 3C. FIGS. 3A-3D show a container 300 comprising similar components to those of FIGS. 1 and 2A-2B. Container 300 comprises a cylindrical jar 302 with two combs 320 mounted vertically therein. It should be appreciated that any number of combs may be mounted depending on the size of the jar and size and shape of the combs. Top 304 is fixedly attached to threaded rod 306 such that rotation of top 304 results in rotation of rod 306. Top 304 optionally comprises an arrow 305 embossed or printed on its upper surface as shown in FIG. 3B to indicate the correct direction that top 304 should be rotated in.

Rod 306 is threaded through a threaded opening (not shown) in compression surface 310 such that rotation of rod 306 results in movement of surface 310 either upwards or downwards inside jar 302. Surface 310 is itself prevented from turning by alignment strip 314. Strip 314 is fixedly attached to the side of jar 302 and extends along the side of jar 302 for the length of travel of surface 310. Surface 310 is provided around its outside with seal 318 to prevent extracted honey from leaking above surface 310.

Honeycomb 320 is mounted vertically inside jar 302, optionally on optional mounting substrate 322 which secures comb 320 in an upright position. Optional substrate 322 is fixedly attached to the base of jar 302. Spout 330 is provided at the bottom of jar 302 for dispensing of extracted honey. Container 300 optionally comprises a filter (not shown) as described above with reference to FIG. 1A.

Operation of container 300 is similar to that described with reference to FIGS. 2A-2B. Rotation of top 304 results in movement of surface 310 to compress comb 320 to extract honey which exits through spout 330.

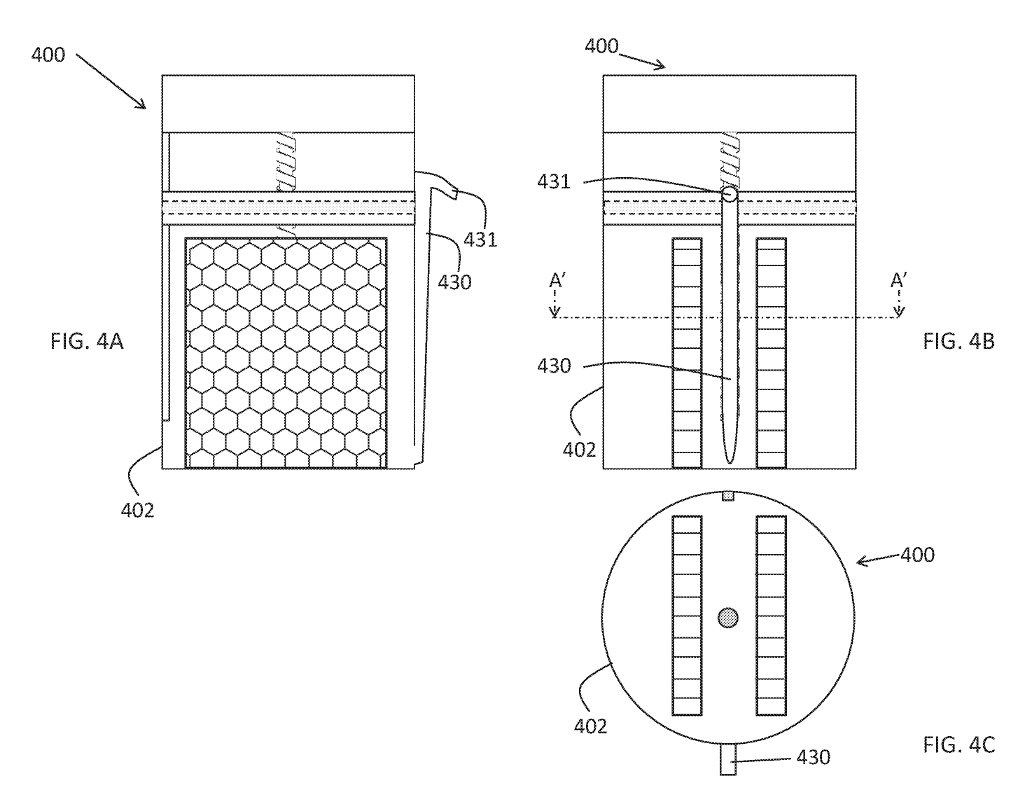

Reference is now made to FIGS. 4A-4C which are respectively side, rotated side and cross-sectional plan schematic illustrations of an instant honey extraction and dispensing container according to at least some embodiments of the present invention. FIGS. 4B and 4C are rotated 90 degrees with respect to FIG. 4A. FIG. 4C is a cross section A′-A′ of FIG. 4B. FIGS. 4A-4C show a container 400 comprising similar components to those of FIGS. 3A-3D. The difference is the spout 430 which extends from the base of jar 402 to a point near top 404 where the dispensing opening 431 is located. The embodiment of FIGS. 4A-4C is designed to provide easier dispensing of extracted honey due to the raised opening 431. It should be appreciated that termination of spout 430 and opening 431 may be at any height along the side of jar 402.

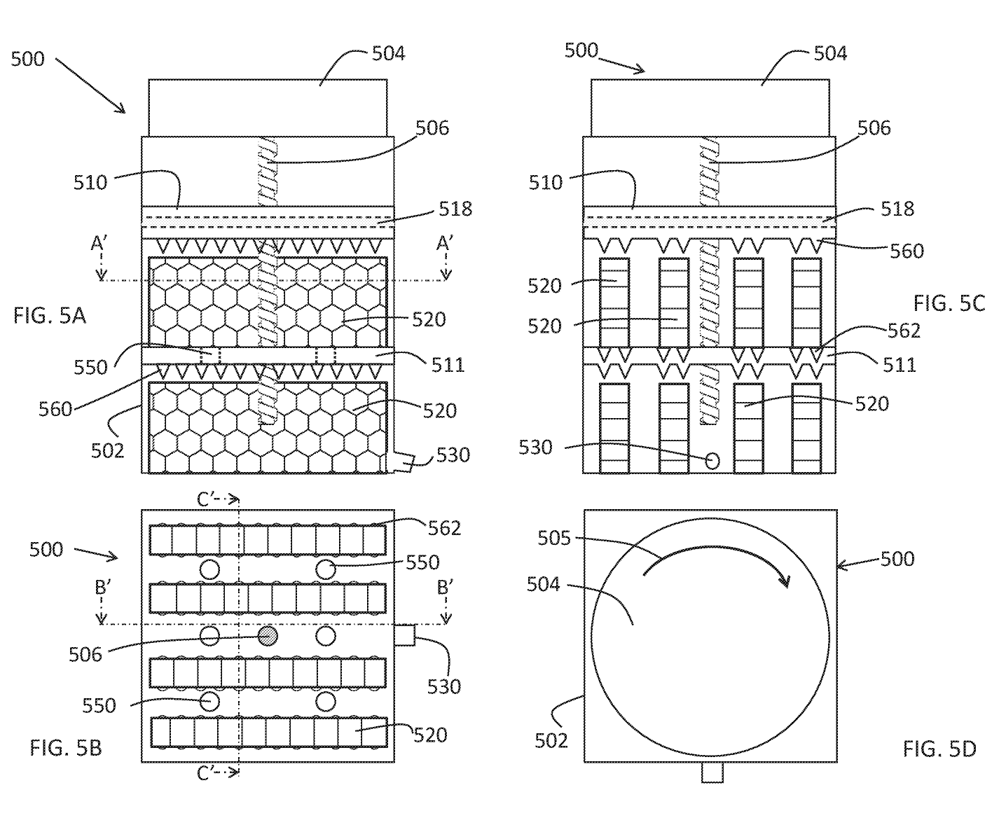

Reference is now made to FIGS. 5A-5D which are respectively side, cross-sectional plan, rotated cross-sectional side and plan schematic illustrations of an instant honey extraction and dispensing container according to at least some embodiments of the present invention. FIGS. 5C and 5D are rotated 90 degrees with respect to FIGS. 5A and 5B. FIG. 5A is a cross section B′-B′ of FIG. 5B. FIG. 5B is a cross section A′-A′ of FIG. 5A. FIG. 5C is a cross section C-C′ of FIG. 5B. FIGS. 5A-5D show a container 500 comprising similar components to those of FIGS. 1 and 2A-2B. Container 500 comprises a square jar 502 with a double layer wherein each layer comprises four combs 520 mounted vertically therein, for a total of eight combs 520. It should be appreciated that any number of combs may be mounted depending on the size of the jar and size and shape of the combs. Optionally more than two layers may be provided.

Top 504 is cylindrical and is fixedly attached to threaded rod 506 such that rotation of top 504 results in rotation of rod 506. Top 504 optionally comprises an arrow 505 embossed or printed on its upper surface as shown in FIG. 5D to indicate the correct direction that top 504 should be rotated in.

Rod 506 is threaded through a threaded opening (not shown)in upper compression surface 510 such that rotation of rod 506 results in movement of surface 510 either upwards or downwards inside jar 502. Lower compression surface 511 is not threaded and as such is forced downwards when upper surface 510 presses down on comb 520 mounted above surface 511. Container 500 has no need for an alignment strip as in embodiments described above due to the square shape of the jar 502. Surface 510 is provided around its outside with seal 518 to prevent extracted honey from leaking above upper surface 510. Drainage holes 550 are provided in lower surface 511 to allow extracted honey to drain through to the bottom of jar 502 and out of spout 530. Container 500 optionally comprises a filter (not shown) as described above with reference to FIG. 1A.

Honeycombs 520 are mounted vertically inside jar 502, optionally on optional mounting substrates (not shown) which secures combs 520 in an upright position. Optional substrates are fixedly attached to the base of jar 502. Spout 530 is provided at the bottom of jar 502 for dispensing of extracted honey.

Container 500 further comprises compression teeth 560 mounted on the underside of surfaces 510 and 511. Teeth 560 are provided to improve the extraction of honey from combs 520. Teeth 560 on upper surface 510 are provided with matching cavities 562 on the upper side of lower surface 511 to allow teeth 560 to settle into cavities 562 once surfaces 510 and 511 meet. Teeth 560 are here shown as cylindrical spikes but it should be appreciated that teeth 560 may be any suitable shape including flat spikes or pins.

Operation of container 500 is similar to that described with reference to FIGS. 2A-2B. Rotation of top 504 results in movement of surfaces 510 and 511 to compress combs 520 to extract honey which exits through spout 530.

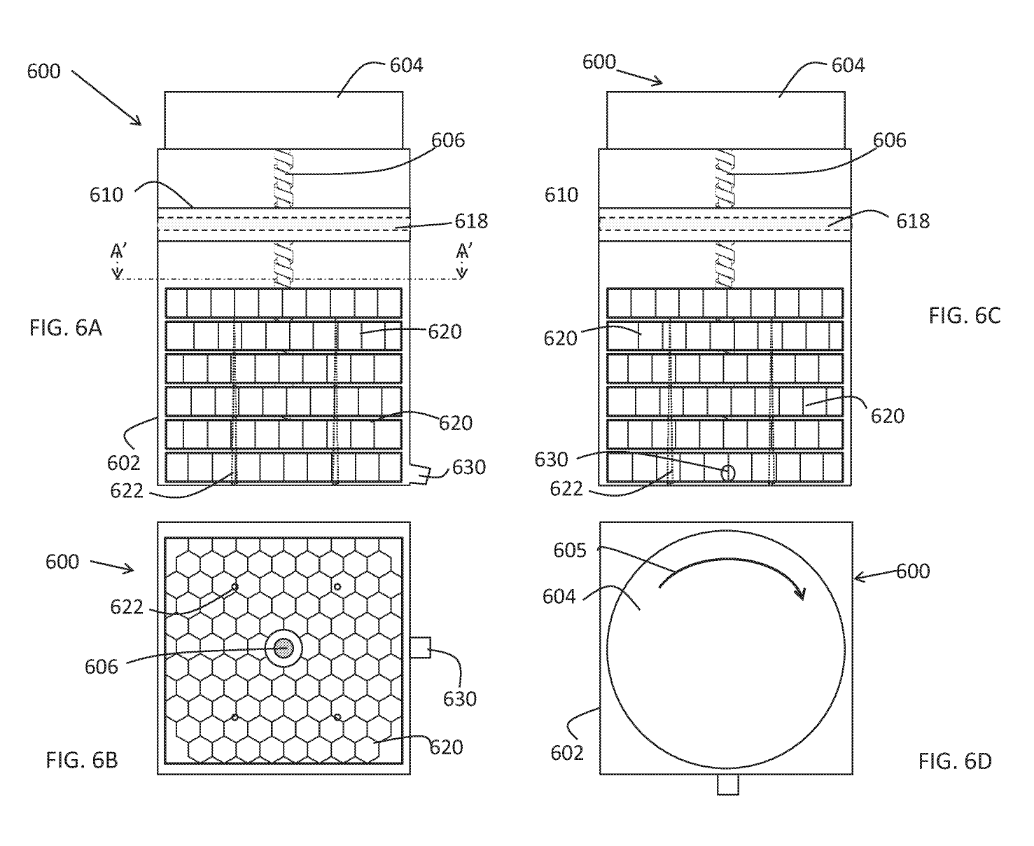

Reference is now made to FIGS. 6A-6D which are respectively side, cross-sectional plan, rotated side and plan schematic illustrations of an instant honey extraction and dispensing container according to at least some embodiments of the present invention. FIGS. 6C and 6D are rotated 90 degrees with respect to FIGS. 6A and 6B. FIG. 6B is a cross section A′-A′ of FIG. 6A. FIGS. 6A-6D show a container 600 comprising similar components to those of FIGS. 1 and 2A-2B. Container 600 comprises a square jar 602 wherein the combs 620 are stacked and laid horizontally one on top of the other. Although six combs are shown it should be appreciated that any number of combs may be mounted depending on the size of the jar and size and shape of the combs. Top 604 is cylindrical and is fixedly attached to threaded rod 606 such that rotation of top 604 results in rotation of rod 606. Top 604 optionally comprises an arrow 605 embossed or printed on its upper surface as shown in FIG. 6D to indicate the correct direction that top 604 should be rotated in.

Rod 606 is threaded through a threaded opening (not shown) in compression surface 610 such that rotation of rod 606 results in movement of surface 610 either upwards or downwards inside jar 602. Container 600 has no need for an alignment strip as in embodiments described above due to the square shape of the jar 602. Surface 610 is provided around its outside with seal 618 to prevent extracted honey from leaking above surface 610.

Honeycombs 620 are mounted horizontally inside jar 602, optionally on optional deformable mounting pins 622 which secure combs 620 in position. Optional pins 622 are fixedly attached to the base of jar 602. Spout 630 is provided at the bottom of jar 602 for dispensing of extracted honey. Container 600 optionally comprises a filter (not shown) as described above with reference to FIG. 1A.

Operation of container 600 is similar to that described with reference to FIGS. 2A-2B. Rotation of top 604 results in movement of surface 610 to compress combs 620 to extract honey which exits through spout 630.

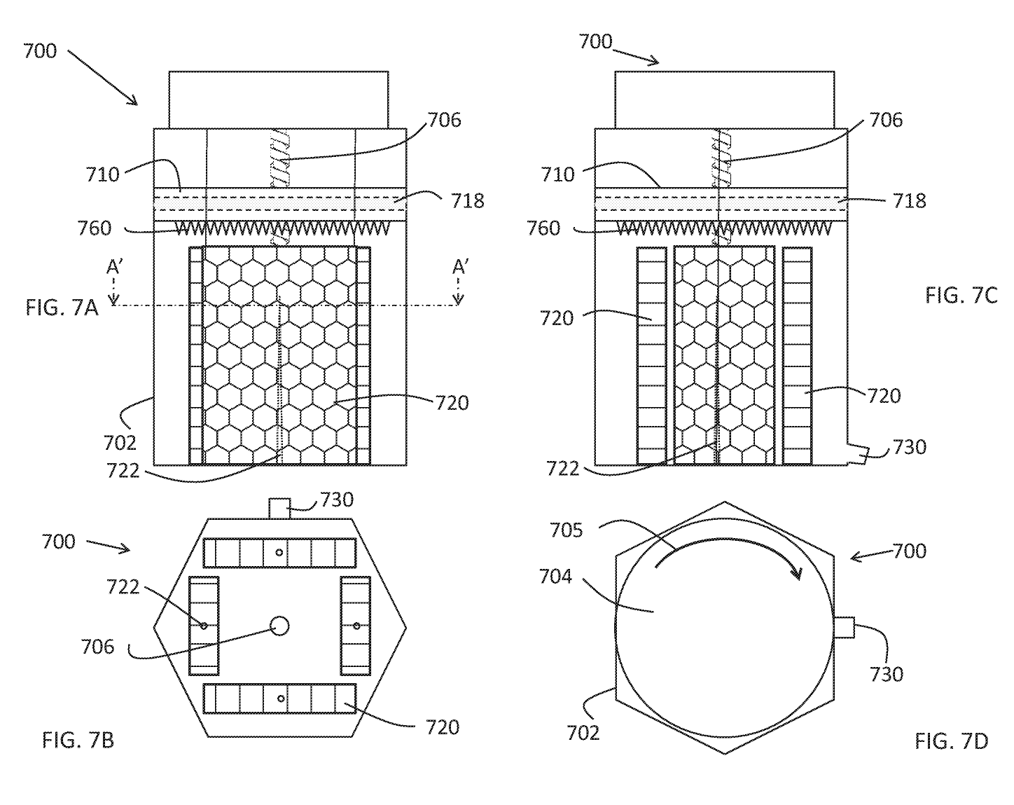

Reference is now made to FIGS. 7A-7D which are respectively side, cross-sectional plan, rotated side and plan schematic illustrations of an instant honey extraction and dispensing container according to at least some embodiments of the present invention. FIGS. 7C and 7D are rotated 90 degrees with respect to FIGS. 7A and 7B. FIG. 7B is a cross section A′-A′ of FIG. 7A. FIGS. 7A-7D show a container 700 comprising similar components to those of FIGS. 1 and 2A-2B. Container 700 comprises a hexagonal jar 702 wherein the combs 720 are arranged to make the most efficient use of the space afforded by the hexagonal jar 702. Although four combs are shown it should be appreciated that any number of combs may be mounted depending on the size of the jar and size and shape of the combs.

Top 704 is cylindrical and is fixedly attached to threaded rod 706 such that rotation of top 704 results in rotation of rod 706. Top 704 optionally comprises an arrow 705 embossed or printed on its upper surface as shown in FIG. 7D to indicate the correct direction that top 704 should be rotated in.

Rod 706 is threaded through a threaded opening (not shown) in compression surface 710 such that rotation of rod 706 results in movement of surface 710 either upwards or downwards inside jar 702. Container 700 has no need for an alignment strip as in embodiments described above due to the hexagonal shape of the jar 702. Surface 710 is provided around its outside with seal 718 to prevent extracted honey from leaking above surface 710.

Container 700 further comprises compression teeth 760 mounted on the underside of surface 710. Teeth 760 are provided to improve the extraction of honey from combs 720. Teeth 760 are here shown as cylindrical spikes but it should be appreciated that teeth 760 may be any suitable shape including flat spikes or pins,

Honeycombs 720 are mounted vertically inside jar 702, optionally on optional deformable mounting pins 722 which secure combs 720 in position. Optional pins 722 are fixedly attached to the base of jar 702. Spout 730 is provided at the bottom of jar 702 for dispensing of extracted honey. Container 700 optionally comprises a filter (not shown) as described above with reference to FIG. 1A.

Operation of container 700 is similar to that described with reference to FIGS. 2A-2B. Rotation of top 704 results in movement of surface 710 to compress combs 720 to extract honey which exits through spout 730.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

While the invention has been described with respect to a limited number of embodiments, it will be appreciated that many variations, modifications and other applications of the invention may be made,

1. A honey extraction and dispensing container comprising:
a. a jar;
b. a rotatable lid mounted on top of said jar such that said jar is a sealed jar;
c. a threaded rod attached to the underside of said lid;
d. a compression surface wherein said threaded rod is threaded through a threaded opening in said surface; and
e. at least one honeycomb mounted beneath said surface inside said sealed jar;
wherein rotation of said lid causes rotation of said threaded rod through said threaded opening causing said surface to descend and to compress said honeycomb, wherein said lid does not descend during said rotation.

2. The container of claim 1 where said compression of said honeycomb results in the extraction of honey from said honeycomb.

3. The container of claim 2 further comprising a spout, wherein extracted honey is drained through said spout.

4. The container of claim 3 further comprising a cap to close said spout.

5. The container of claim 3 further comprising a filter positioned before the drainage of the extracted honey from said jar.

6. The container of claim 5 wherein said filter is a cleanable filter.

7. The container of claim 1 wherein said lid is not removable such that said jar cannot be reused.

8. The container of claim 1 wherein said honeycomb is mounted inside said jar using at least one of, pressure mounting, mounting pins or a mounting substrate.

9. The container of claim 1 further comprising a seal positioned between said surface and said jar.

10. The container of claim 1 further comprising compression teeth mounted on the underside of said surface.

11. The container of claim 1 further comprising an alignment strip fixedly attached to the inside of said jar.

12. The container of claim 1 wherein said honeycomb is mounted vertically.

13. The container of claim 1 wherein said honeycomb is mounted horizontally.

14. The container of claim 1 further comprising a plurality of layers of honeycomb each mounted on separate surfaces.

15. The container of claim 1 wherein said container is not reusable.

16. The container of claim 1 wherein the shape of said jar is selected from the group consisting of circular, square, rectangular, and hexagonal.

17. A honey extraction and dispensing container for extracting honey from a honeycomb comprising:
a. a jar;
b. a rotatable lid mounted on top of said jar such that said jar is a sealed jar;
c. a threaded rod attached to the underside of said lid; and
d. a compression surface wherein said threaded rod is threaded through a threaded opening in said surface;
wherein rotation of said lid causes rotation of said threaded rod through said threaded opening causing said surface to descend and to compress a honeycomb mounted in said jar, wherein said lid does not descend during said rotation.

18. A honey extraction and dispensing system comprising:
a. a sealed, non-reusable jar;
b. a rotatable, non-removable lid mounted on top of said jar for sealing said jar;
c. a threaded rod attached to the underside of said lid;
d. a compression surface wherein said threaded rod is threaded through a threaded opening in said surface; and
e. at least one honeycomb mounted beneath said surface inside said jar;
wherein rotation of said lid causes rotation of said threaded rod through said threaded opening causing said surface to descend and compress said honeycomb, wherein said lid does not descend during said rotation.

19. The system of claim 18 wherein the dimensions of said jar are selected from the group consisting of:
a. up to 40 cm high;
b. up to 30 cm wide;
c. up to 30 cm long; and
d. a combination of the above.

20. The system of claim 18, wherein said container weighs less than 5 kg.

21. The container of claim 1 further comprising a seal positioned between said threaded opening and said rod.
